(19) United States
(12) Patent Application Publication
(10) Pub. No.: US 2007/0292063 A1
(43) Pub. Date: Dec. 20, 2007

(54) Process for Manufacturing an Elastomer Bearing, Bush Bearing Manufactured According to Same, and Device for Manufacturing

(76) Inventors: Stefan Loheide, Wallenhorst (DE); Ulrich Bladt, Ibbenburen (DE); Gunter Lohfink, Bad Harzburg (DE); Eckhard Jantzen, Diepholz (DE)

Correspondence Address: MCGLEW & TUTTLE, PC, P.O. BOX 9227, SCARBOROUGH STATION, SCARBOROUGH, NY, 10510-9227, US

(21) Appl. No.: 11/719,016

(22) PCT Filed: Nov. 11, 2005
(86) PCT No.: PCT/DE05/02039

§ 371 Date: May 10, 2007

(30) Foreign Application Priority Data
Nov. 11, 2004 (DE) 10 2004 054 618.5

(51) Int. Cl. F16C 27/06; B29C 45/00

(52) U.S. Cl. 384/222; 425/149

(57) ABSTRACT

A process for manufacturing an elastomer bearing is provided as well as a bush bearing as well as a device for manufacturing a corresponding bush bearing. Elastomer bearings of a compact design are obtained, in which a prestress of a predetermined value can be generated in the elastomer bearing body during the manufacturing process in a simple manner. In particular, the manufacture of bush bearings with high radial rigidity, which have a favorable characteristic against cardanic and torsional loads and preferably meet high requirements on the pressing-out force, is made possible. The inner surfaces of an injection mold for producing a plastic sleeve for the bearing and the outer sleeve of the elastomer bearing body are contoured such that at least one chamber-like free space, into which the elastomer of the bearing body is displaced during the extrusion coating operation by the plastic introduced under pressure, while a prestress is generated at the same time in the elastomer, remains between them after the closing of the injection mold with the still not extrusion-coated bearing inserted.

### CROSS REFERENCE TO RELATED APPLICATIONS

This application is a United States National Phase application of International Application PCT/DE2005/002039 and claims the benefit of priority under 35 U.S.C. § 119 of German Patent Application DE 10 2004 054 618.5 filed Nov. 11, 2004, the entire contents of which are incorporated herein by reference.

### FIELD OF THE INVENTION

The present invention pertains to a process for manufacturing an elastomer bearing, preferably a rubber bearing, and to a bush bearing manufactured according to same. The present invention pertains, furthermore, to a device for manufacturing a corresponding bush bearing or sleeve bearing.

### BACKGROUND OF THE INVENTION

Elastomer bearings, especially rubber bearings, are widely used in the automobile industry for mounting chassis components, such as chassis control arms. Very high dynamic requirements are imposed here on the bearings, and these requirements increase steadily with regard to a steady improvement of driving performance and comfort. The aim is to design bearings of a compact design such that they have a high radial rigidity along with low rigidity under cardanic and torsional loads.

Bush bearings, which have, in general, a concentric design and comprise an inner part, an outer part surrounding the inner part and an elastomer bearing body inserted between them, are widely used especially for the chassis control arms. The bearing parts are connected to one another in most cases adheringly by vulcanization. The radial rigidity the bearings are frequently required to have is attained by radially upsetting the elastomer bearing body or rubber body, i.e., by generating a radial prestress in the bearing body. The diameter of the cylindrical outer sleeve is reduced for this purpose after the vulcanization of the bearing body between the inner part and the outer part or the outer sleeve in a deformation process and a radial pressure is thus applied to the bearing body by means of the outer sleeve to generate the prestress. One also speaks in this connection of calibration of the bearing. The bearing mounted or calibrated in this manner is finally pressed into the bearing eye of the chassis component in question, which consists of steel or aluminum.

Besides the question of the most compact design possible to reduce the space needed for installation, the weight reduction due to a corresponding design embodiment of the bearings and selection of materials favorable in this respect is also of great significance. Bearings without an outer sleeve are manufactured for special applications, among other things, for this reason as well. However, such a design is considered only if the requirements imposed on the degree of increase in the radial rigidity are not too high and the pressing forces acting on the bearing pressed into the bearing eye during the intended use of the bearing are not too strong. The use of bearings without outer sleeve is therefore usually not considered especially in automotive engineering.

Another possibility of weight reduction utilized in practice is to manufacture individual chassis components from plastic. However, the problem arises in this connection that certain creep characteristics of the plastic are observed, as a result of which permanent interference fit of the bearing with outer sleeve pressed into the mounting eye is not guaranteed. To avoid the problem and to achieve both a weight reduction and reliable interference fit of the bearing, solutions were developed in which a bearing designed at first without an outer sleeve is subsequently coated with a plastic by extrusion coating. The compressive strains necessary for achieving the necessary radial rigidity are generated in the elastomer or in the rubber by means of the injection pressure applied during the extrusion coating with the plastic. Corresponding solutions are described, for example, in JP 63034111A and JP 62101411A. However, the solutions described in the documents inherently have the drawback that no sealing lips are provided on the bearings to prevent oil and dirt from entering from the axial direction. It is thus also impossible to prepare stops acting in the axial direction.

It is also not readily possible to form corresponding seals or sealing lips because of the design embodiment of the bearings and the processes necessary for manufacturing same. Moreover, the possibilities of variable design in terms of flexible adaptation to different dynamic requirements are also rather limited due to the shape of the bearings.

### SUMMARY OF THE INVENTION

The object of the present invention is to propose a solution by which elastomer bearings of a compact design are obtained, in which prestress of a predetermined value can be generated in the elastomer bearing body during the manufacturing process in a simple manner. In respect to elastomer bush bearings or sleeve bearings, the solution to be provided shall make possible the manufacture of bearings with high radial rigidity, which at the same time display a favorable characteristic against cardanic and torsional loads. The latter shall preferably meet high requirements imposed on the pressing-out force after pressing into a mounting eye and be reliably sealed against the entry of dirt and oil. A manufacturing process, a correspondingly shaped bush bearing and a device suitable for manufacturing same shall be proposed for this.

A cylindrical inner part or an inner part of a similar design is provided with an elastomer bearing body surrounding the inner part in the process proposed according to the present invention for manufacturing an elastomer bearing as well, the inner part and the bearing body being preferably connected to one another adheringly by vulcanization. These bearing parts are then extrusion-coated with a plastic in an injection mold in the known manner, forming an outer sleeve. Corresponding to the present invention, the inner surfaces of the injection mold and the outer surfaces of the elastomer bearing body are, however, contoured such that at least one chamber-like free space is left between them after the injection mold with the still uncoated bearing inserted has been closed. The plastic is introduced according to the present invention into the mold and at least into a filling space formed therein during the injection molding operation under a pressure by which the elastomer of the bearing body is displaced into the aforementioned free space or chamber while a prestress is generated in the elastomer. The chamber is separated from the plastic filling space during the entire injection molding operation by the sections of the elastomer of the bearing body that are displaced into the chamber during the injection molding operation and is completely filled with the elastomer, which is under prestress, after the end of the injection molding operation but before the bearing is removed from the mold. Bearings of a compact design and low weight, which meet the dynamic requirements imposed for many applications and have, in particular, a low rigidity under cardanic and torsional load despite high radial rigidity, can be manufactured by means of the process according to the present invention.

A special advantage is that the dynamic characteristic of a bearing manufactured according to the process according to the present invention is not determined by the pressure occurring during the injection of the plastic, but by the shape of the chamber or chambers formed on the basis of the contouring of the injection mold and the bearing body. The dynamic characteristic can be set flexibly, corresponding to different requirements, due to the shaping of the chambers and by selecting the material. It is possible now to manufacture a plurality of bearings with different dynamic designs simultaneously in one injection molding operation.

In a practical implementation of the process for manufacturing an elastomer bush bearing, the plastic is introduced into the mold from the radial direction relative to the bearing inserted into the injection mold. The elastomer of the bearing body is displaced now essentially in the axial direction and pressed into the at least one chamber existing between the bearing body and the inner contour of the injection mold prior to the injection molding operation.

During the manufacture of bush bearings by means of the process according to the present invention, the plastic is preferably injected into a filling space arranged within the mold in an axially central area of the bearing and the elastomer of the bearing body is displaced into two chambers arranged axially on both sides of the filling space.

An elastomer bush bearing manufactured according to the process described above comprises a cylindrical inner part and an elastomer bearing body, which surrounds same and which is extrusion-coated with a plastic forming the outer sleeve in an axially central area. The bearing body has, according to the present invention, a groove in the area extrusion-coated with the plastic. The groove as well as the plastic sleeve surrounding the bearing body in this area are limited axially on both sides by bulges of the elastomer bearing body. These bulges extend behind the axial ends of the plastic sleeve formed after the extrusion coating operation and form an axial seal each for the bearing, which reliably prevent oil or dirt from entering the bearing. At the same time, the bulges extending behind the axial ends of the plastic sleeve may, in addition, also act as axial stops, depending on the design of the bearing, especially the dimensioning of the volume of the chamber and of the elastomer displaced into the chamber.

Corresponding to a special embodiment of the bush bearing intended for mounting the chassis control arms, the plastic sleeve is designed especially advantageously in one piece with the chassis control arm. This means that the bearing sleeve is an integral part of the chassis control arm and is manufactured in one injection molding operation together with same.

With regard to the manufacture of the elastomer bush bearing according to the process explained above, various possibilities can be considered for contouring the bearing body of this bearing, but especially for shaping the groove formed therein. According to an intended embodiment, the groove has a shape approximately corresponding to a circumferential section of a circle relative to the projection of its axial cross section prior to the extrusion coating with the plastic.

Corresponding to another possible embodiment, the groove has a trapezoidal shape prior to being extrusion-coated with the plastic and the displacement of the bulges limiting same, which takes place in the process, likewise relative to the projection of its axial cross section. Another advantageous embodiment is given by the groove having a radial undercut at at least one of its axial ends. In particular, the latter embodiment is especially well suited for increasing the pressing force of the bearing.

The injection mold suitable for carrying out the process claimed and designed for manufacturing the elastomer bush bearing according to the present invention comprises, at first, in a primarily known manner, means for fixing the bearing during the extrusion coating operation and at least one plastic filling space, into which the plastic is introduced under pressure to form an outer sleeve for the bearing, which comprised up to now a cylindrical inner part and an elastomer bearing body surrounding the inner part. The mold has, according to the present invention, at least one insert, whose inner contour forms, together with the outer contour of the elastomer bearing body of the bearing inserted into the mold, a chamber, which extends in the circumferential direction of the bearing, is kept free before the extrusion coating operation and into which the elastomer of the bearing body is displaced by the plastic introduced into the plastic filling space under pressure. The inner contour of the insert of the mold and the outer contour of the bearing body are such that the elastomer, being under prestress, completely fills out the chamber after the extrusion coating operation. This means that the volume of the chamber or chambers kept free prior to the extrusion coating is smaller than the volume of the elastomer areas of the bearing body displaced by the injection pressure. In addition, a step, which separates the plastic filling space from the chamber or chambers and is overcome by the elastomer of the bearing body displaced into the chamber(s) during the extrusion coating operation, is formed at the inner contour of the insert of the mold at the inlet of the chamber or chambers. It is ensured in this manner that the plastic does not enter the chambers formed between the bearing body and the insert of the mold during the extrusion coating of the bearing body.

Both the process-related aspects and the device-related aspects of the present invention shall be explained once again in more detail below on the basis of exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1a is a cut-away sectional and schematic view of the essential part of the device for manufacturing the bearing;

FIG. 1b is a cut-away sectional and schematic view of the device according to FIG. 1a with the bearing inserted;

FIG. 2a is a detail sectional view of the elastomer bearing before the extrusion coating;

FIG. 2b is a detail sectional view according to FIG. 2a after the extrusion coating of the bearing;

FIG. 3a is an axially cut-away sectional view of an embodiment of the bearing according to the present invention, before the extrusion coating with the plastic;

FIG. 3b is an axially cut-away sectional view of the bearing according to FIG. 3a after the extrusion coating;

FIG. 4 is a detail sectional view of another possible embodiment of the bearing; and

FIG. 5 is a detail sectional view of another possible embodiment of the bearing.

### DESCRIPTION OF THE PREFERRED EMBODIMENTS

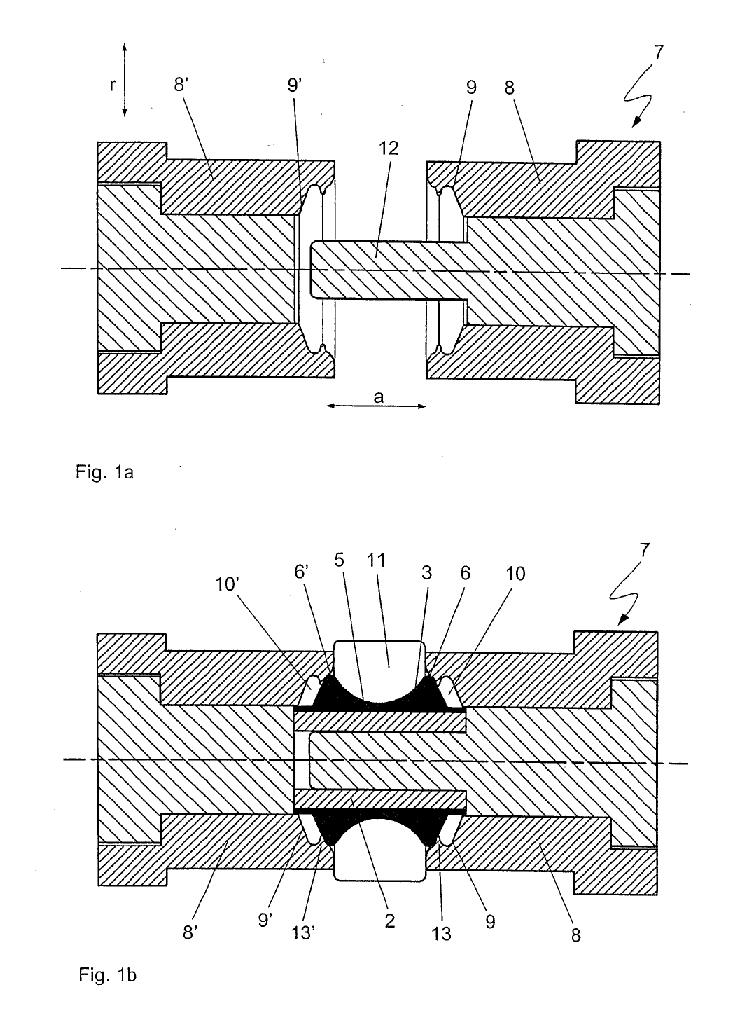

Referring to the drawings in particular, FIGS. 1a and 1b show a cut-away view of the essential part of an embodiment of the device according to the present invention for manufacturing an elastomer bearing 1. These are parts of the mold 7 used for extrusion coating of the bearing 1 with the plastic, which parts are shown schematically. FIG. 1a shows the empty mold 7 and FIG. 1b the same mold 7 with a bearing 1 inserted into it. The position of the bearing 1 is fixed for the extrusion coating operation by means of insert parts 12 arranged in the mold 7, especially a mandrel passing through the hollow cylindrical inner part 2 of the bearing 1. Furthermore, the mold 7 comprises, in keeping with the basic idea of the solution according to the present invention, specially contoured inserts 8, 8′, which lead to the design of the bearing 1 according to the present invention in connection with the injection of the plastic, which takes place under pressure. As can be recognized from FIG. 1b, the bearing 1 is inserted into the mold 7 and is extrusion-coated with plastic in the area of the plastic filling space 11 schematically symbolized in the figure after the mold 7 has been closed. The elastomer or the rubber of the bearing body 3 is displaced by the pressure during the injection of the plastic into the plastic filling space 11 from its original shape into the chambers 10, 10′ formed because of the contouring of the inserts 8, 8′ and of the bearing body 3. The elastomer moving into the chambers 10, 10′ must now overcome a step 13, 13′ formed on the inner contour 9, 9′ of the inserts 8, 8′. These steps 13, 13′ assume a dual function. On the one hand, as will be explained later, an undercut is formed by them on the bearing 1 in the area of the transition between the plastic sleeve or outer sleeve 4 surrounding the bearing body 3 after the extrusion coating and the bearing body 3 and, on the other hand, they prevent, coordinated with the outer contour of the bearing body 3 and the other contouring of the inserts 8, 8′, plastic from entering the chambers 10, 10′ formed during the extrusion coating operation. The desired radial compressive strain is built up in the bearing body 3 by the pressure occurring during the injection and the displacement of the elastomer, which is associated therewith. This compressive strain leads to the desired high radial rigidity of the bearing 1.

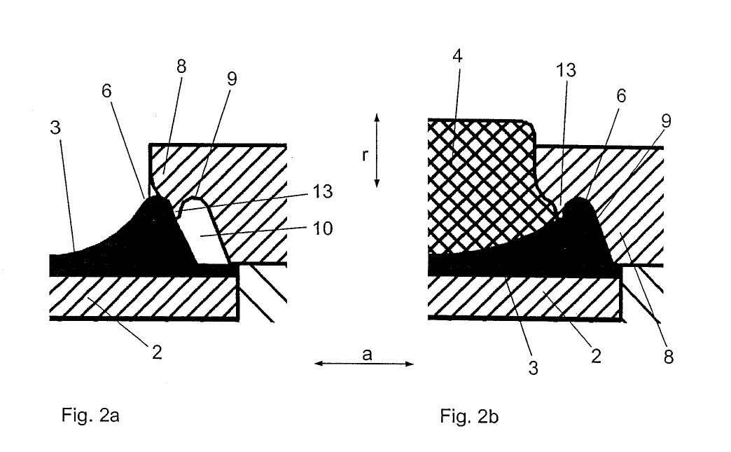

FIGS. 2a and 2b show a detail of the bearing 1 according to the present invention, which illustrates the operations involved in the extrusion coating of the bearing. FIG. 2a shows the corresponding detail—an axial end of the bearing 1 with an area of the inner part 2 and with a detail of the bearing body 3 surrounding the inner part—inserted into the injection mold 7, but not yet extrusion-coated with the plastic. The same detail is shown in FIG. 2b once again after the extrusion coating. It can be clearly recognized here that the elastomer or the rubber has been displaced into the chamber 10, which was still free in FIG. 2a, by the pressure applied during the injection. The elastomer has now overcome the step 13 formed on the inner contour 9 of the insert 8 and has adapted itself to this inner contour 9. Due to the fact that the volume of the area of the elastomer bearing body 3 displaced into the chamber 10 is actually somewhat larger than the chamber volume, the elastomer that has nevertheless been displaced into the chamber 10 by the pressure during the injection of the plastic is under a desired prestress within the chamber 10.

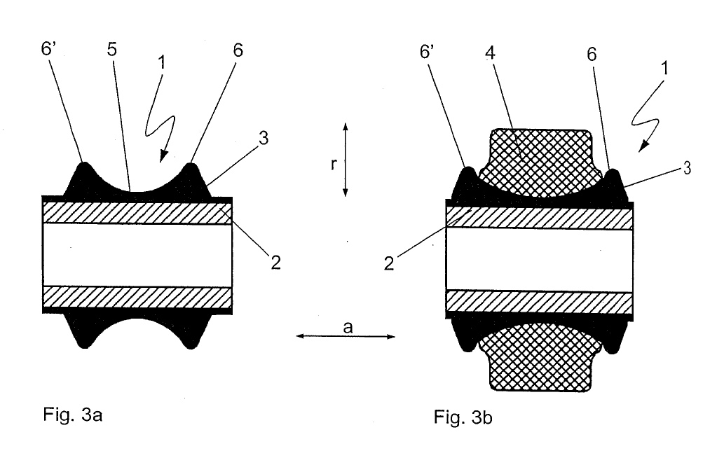

FIGS. 3a and 3b show the bearing 1 as a whole once again in an axially cut-away view. FIG. 3a shows the bearing 1 before the extrusion coating with the plastic. As can be recognized, the elastomer bearing body 3 of the bearing 1 according to the present invention has a special contouring, namely, a certain shape of its outer contour. In an axially central area, the bearing body has a grooved section 5, which approximately corresponds to the circumferential section of a circle at least before the extrusion coating of the bearing 1 with plastic in the embodiment shown as an example. In any case, the groove 5 is limited axially by radially rising bulges 6, 6′. The steps 13, 13′ on the inserts 8, 8′ of the mold 7 and the bulges 6, 6′ of the bearing body 3 are designed such that the elastomer can overcome the steps 13, 13′ and be displaced into the chambers 10, 10′ only at a very specific pressure applied to the bearing body 3 during the extrusion coating with the plastic. The prestress introduced into the bearing body 3 and hence ultimately also the radial rigidity of the bearing 1 are then also set by means of this. FIG. 3b shows the bearing 1 after the extrusion coating with the plastic. It can be recognized that the bulges 6, 6′ of the elastomer bearing body 3 have migrated axially outwardly on both sides and form an axial seal extending behind the outer sleeve 4 consisting of plastic as well as an axial stop due to the undercut formed.

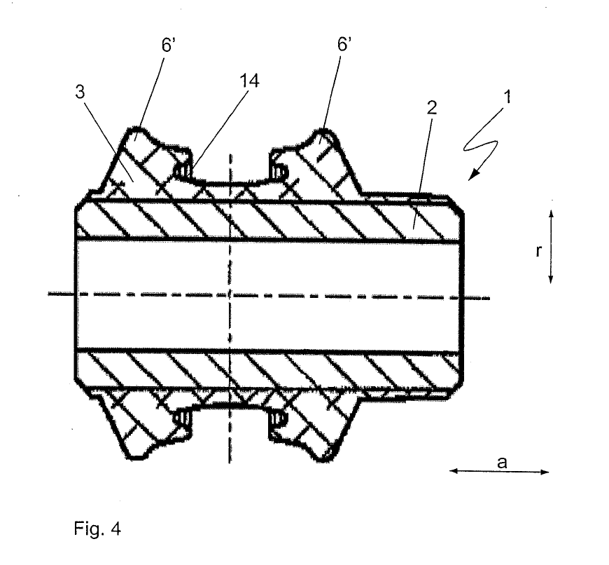

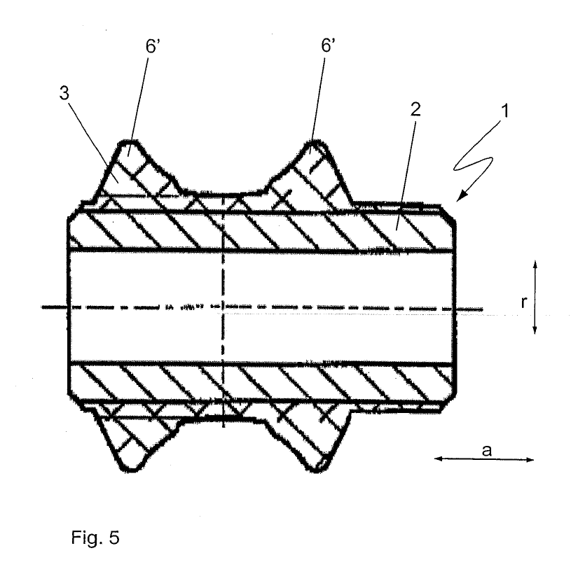

While maintaining the basic idea of the invention, various materials can also be used for the bearing body 3 with respect to the desired prestress, and, concerning the bearing geometry, various shapes of the groove 5 of the bearing body 3, of the bulges 6, 6′ axially liming the groove 5 and of the inner contour 9, 9′ of the inserts 8, 8′ of the injection mold 7 are conceivable. However, the basic consideration, according to which the bearing body 3 has a groove in a middle area and the bulges 6, 6′ liming the grooved area or the groove 5 are displaced into corresponding chambers 10, 10′ in the injection mold 7 during the extrusion coating with the plastic, is always maintained. On the one hand, the prestress or the axial rigidity for the bearing 1 is set hereby. On the other hand, a sealing lip, which reliably prevents dirt and oil from entering the bearing, is formed by the undercut, which is formed after the extrusion coating in the area of the elastomer extending behind the two axial ends of the outer sleeve 4. FIGS. 4 and 5 illustrate examples of other possibilities of profiling the outer contour of the bearing body 3 as well as of the inner contour 9, 9′ of the inserts 8, 8′ of the injection mold 7. In the embodiment shown in FIG. 4, the bearing body 3 has a radial undercut 14 in the area of the groove 5.

While specific embodiments of the invention have been shown and described in detail to illustrate the application of the principles of the invention, it will be understood that the invention may be embodied otherwise without departing from such principles.

1. A process for manufacturing an elastomer bearing, the process comprising:
extrusion coating a bearing inner part an elastomer bearing body surrounding said inner part with a plastic in an injection mold to form an outer sleeve;
providing inner surfaces of said injection mold and the outer surface of said bearing body with contours such that at least one free space is left between said contours and said injection mold after the closure of said injection mold with the not yet extrusion-coated bearing inserted; and
introducing the plastic during a subsequent injection molding operation into said mold and at least into a filling space formed therein under a pressure, by which said bearing body is displaced, while generating a prestress in the elastomer, into the at least one said free space, which free space is separated from said plastic filling space by the elastomer of said bearing body during the entire injection molding operation and is completely filled with the elastomer, which is under prestress, after the end of the injection molding operation as well as before said bearing is removed from the mold.

2. A process in accordance with claim 1 for manufacturing a elastomer bush bearing, wherein the plastic is introduced into said mold in a radial direction relative to said bearing inserted into said injection mold and the elastomer of said bearing body is displaced essentially in an axial direction and is pressed in the process into said at least one free space.

3. A process in accordance with claim 2, wherein two free spaces are provided and the plastic is injected into said plastic filling space arranged within said mold in an axially central area of said bearing and the elastomer of said bearing body has two portions with each being displaced into one of said two free spaces arranged axially on both sides of said filling space.

4. An elastomer bush bearing comprising:
a cylindrical inner part
an elastomer bearing body which surrounds said cylindrical inner part; and
an outer sleeve, said elastomer bearing body being extrusion-coated in an axially central area with a plastic forming said outer sleeve, said bearing body being grooved in an area extrusion-coated by the plastic said groove (5) as well as said plastic sleeve surrounding said bearing body being limited by bulges of the elastomer bearing body axially on both sides, said bulges extending behind axial ends of said sleeve and each forming an axial seal for said bearing.

5. An elastomer bush bearing in accordance with claim 4, wherein said bulges extending behind the axial ends of said sleeve form an axial stop.

6. An elastomer bush bearing in accordance with claim 4 wherein said outer sleeve is made in one piece with a chassis control arm.

7. An elastomer bush bearing in accordance with claim 4, wherein the projection of the axial cross section of said groove formed in said elastomer bearing body has a shape approximately corresponding to a circumferential section of a circle before the extrusion coating with the plastic.

8. An elastomer bush bearing in accordance with claim 4, wherein the projection of the axial cross section of said groove formed in said elastomer bearing body has a trapezoidal shape before extrusion coating with the plastic.

9. An elastomer bush bearing in accordance with claim 4, wherein said groove formed in said elastomer bearing body has a radial undercut at at least one of its axial ends.

10. An injection mold for manufacturing an elastomer bush bearing, the injection mold comprising:
means for fixing the bearing during the extrusion coating operation with at least one plastic filling space, into which the plastic is introduced under pressure to form an outer sleeve for an intermediate stage bearing, which comprises a cylindrical inner part and an elastomer bearing body surrounding said inner part;
a mold having an inner contour cooperating with an outer contour of said elastomer bearing body of said bearing inserted into said mold, to form a chamber, which extends in the circumferential direction of the bearing that is kept free before the extrusion coating operation and into which the elastomer of said bearing body is displaced by the plastic introduced into said plastic filling space under pressure, being under prestress and completely filling said chamber, wherein a step (13, 13′), which separates said plastic filling space from said chamber and is overcome by the elastomer of said bearing body displaced into the chamber during the extrusion coating operation, is formed on said inner contour of said insert, at the inlet of said chamber.
